(19) United States
(12) Patent Application Publication
(10) Pub. No.: US 2007/0168344 A1
(43) Pub. Date: Jul. 19, 2007

(54) Data product search using related concepts

(76) Inventors: Robert M. Brinson JR., Eagle, ID (US); Nicholas Levi Middleton, Cartersville, GA (US); Bryan Glenn Donaldson, Cumming, GA (US)

Correspondence Address: BLACK LOWE & GRAHAM, PLLC, 701 FIFTH AVENUE, SUITE 4800, SEATTLE, WA, 98104, US

(21) Appl. No.: 11/336,743

(22) Filed: Jan. 19, 2006

(51) Int. Cl. G06F 17/30

(52) U.S. Cl. 707/5

(57) ABSTRACT

Systems and methods for searching data. A search for related terms is initiated of at least one data product using at least one term. A ranked list of all the terms in the matching data products is returned and the ranked list is displayed to a user. The user modifies the weight values of a search term or adds a new term to the query. The search is reinitiated using the modified weight values. Alternatively, a search for data products is initiated of at least one data product using at least one term. A ranked list of all data products and significant terms in those products is returned and the ranked list is displayed to a user. The user modifies the weight values of a search term or adds a new term to the query. The search is reinitiated using the modified weight values.

### FIELD OF THE INVENTION

This invention relates generally to computer software and, more specifically, to conducting a search using related concepts.

### BACKGROUND OF THE INVENTION

Current implementations of web search systems perform adequately for finding some of the websites that may have the information a user seeks. However, the search results commonly contain many sites that have little to do with what the user actually wanted to find, either because the user used insufficient terms to identify the pages, phrased the query poorly or was unfamiliar with correct terms necessary to find the pages.

Current technology only allows users to use a hit and miss style of searching. Users will enter a word that they feel is related to the desired search result. Then if the result is not in the first 2 pages of results they may consider the search a failure. The process then starts over again, requiring the user to further narrow their search.

Finally, when a user searches a word, such as “bass,” is the user searching for sites on fishing, guitars, shoes, a graphics designer, a congressman, or the English Ale. Somewhere in the 40 to 50 million sites returned by the query the pages the user seeks can be found. Therefore there exists the need for a search that leads the user to the correct query or significant terms to narrow a search to relevant pages using a network of related pages.

### SUMMARY OF THE INVENTION

The present invention includes systems and methods for searching data. A search for related terms is performed using at least one searchable term. A ranked list of terms found in the search is returned and the ranked list is displayed to a user. The user, in one embodiment, then modifies the weight of terms in the ranked list or one of the search terms or adds a new term to the query. Another search is performed based on the modification with a new ranked list. The new ranked list is displayed on a graphical user interface. Alternatively, a search for data products is performed using at least one searchable term. A ranked list of data products and significant terms within each data product are returned and the ranked list is displayed to a user. The user, in one embodiment, then modifies the weight of terms in the ranked list or one of the search terms or adds a new term to the query. Another search is performed based on the modification with a new ranked list. The new ranked list is displayed on a graphical user interface. In a third alternative, a search for similar queries is performed using at least one searchable term. A ranked list of similar queries and the data products accessible from the queries are returned and the ranked list is displayed to a user. The user, in one embodiment, then modifies the weight of terms in the ranked list or one of the search terms or adds a new term to the query. Another search is performed based on the modification with a new ranked list. The new ranked list is displayed on a graphical user interface.

### BRIEF DESCRIPTION OF THE DRAWINGS

The preferred and alternative embodiments of the present invention are described in detail below with reference to the following drawings.

FIG. 1 shows an example system for executing a search based on related concepts;

FIG. 2 shows an example method formed in accordance with an embodiment of the present invention;

FIG. 3 shows an example method for parsing data products and retrieving words in accordance with a first embodiment;

FIG. 4 shows a method for weighting terms in data products in accordance with an embodiment of the present invention;

FIG. 5 shows an example method for searching based upon complex terms in accordance with an embodiment of the present invention;

FIG. 6A shows an embodiment of optionally executing any of 3 search functions in accordance with another embodiment;

FIG. 6B shows an embodiment of producing a list of related terms for a query in accordance with an embodiment of the present invention;

FIG. 6C shows an embodiment of producing a list of data products for a query in accordance with an embodiment of the present invention;

FIG. 6D shows an example method for determining which data products satisfy a query and how closely a given data product matches a query, in accordance with another embodiment;

FIG. 7 shows an example method for determining additional search terms by offering synonyms and spelling suggestions during a search in a preferred embodiment;

FIG. 8 shows an example method for altering the significance of a search term in accordance with an embodiment of the present invention;

FIG. 9 shows an example method for selecting data products in accordance with an embodiment of the present invention;

FIG. 10 shows an example method for selecting data products in accordance with an embodiment of the present invention;

FIG. 11 shows major database relationship tables formed in accordance with an embodiment of the present invention;

FIG. 12 shows a relationship between search terms and data products in accordance with an embodiment of the present invention;

FIG. 13 shows a relationship between multiple search terms and data products in accordance with an embodiment of the present invention;

FIG. 14 demonstrates the relationship between terms in a chosen subject;

FIG. 15 demonstrates the relationship between terms in a chosen subject and further suggests related terms;

FIGS. 16-22 show graphical user interfaces formed in accordance with an embodiment of the present invention; and

FIG. 23 shows a similarity matrix used to find similar queries formed in accordance with an embodiment of the present invention.

### DETAILED DESCRIPTION OF THE PREFERRED EMBODIMENT

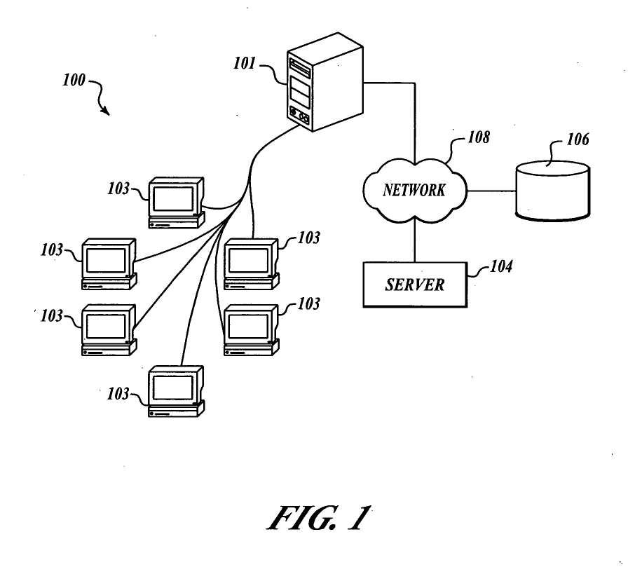

FIG. 1 shows an example system 100 for executing a search based on related concepts. In one embodiment, the system 100 includes a computer 101 in communication with a plurality of other computers 103. In an alternate embodiment the computer 101 can be connected with a plurality of computers 103, a server 104, a data storage center 106, and/or a network 108, such as an intranet or the Internet. In yet another alternate embodiment a bank of servers, a wireless device, a cellular phone and/or another data entry device can be used in the place of the computer 101. In one embodiment, a database stores significant terms and/or similar queries. The database is stored at the center 106 or locally at the computer 101.

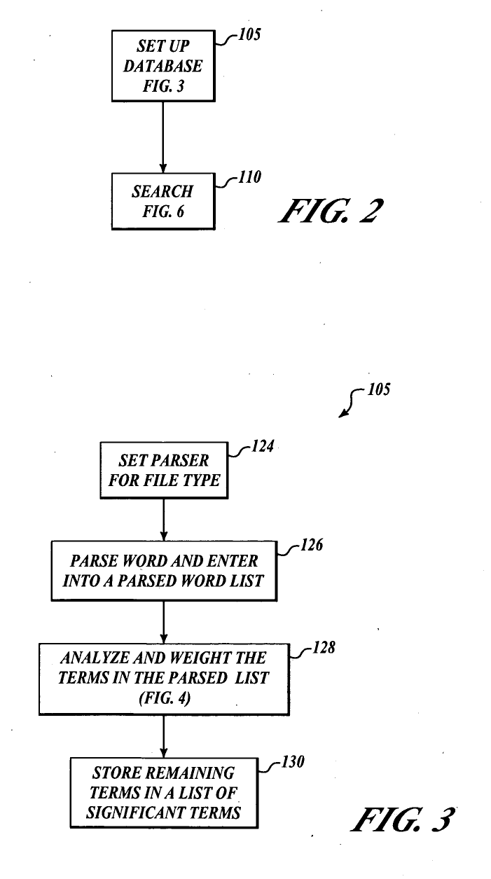

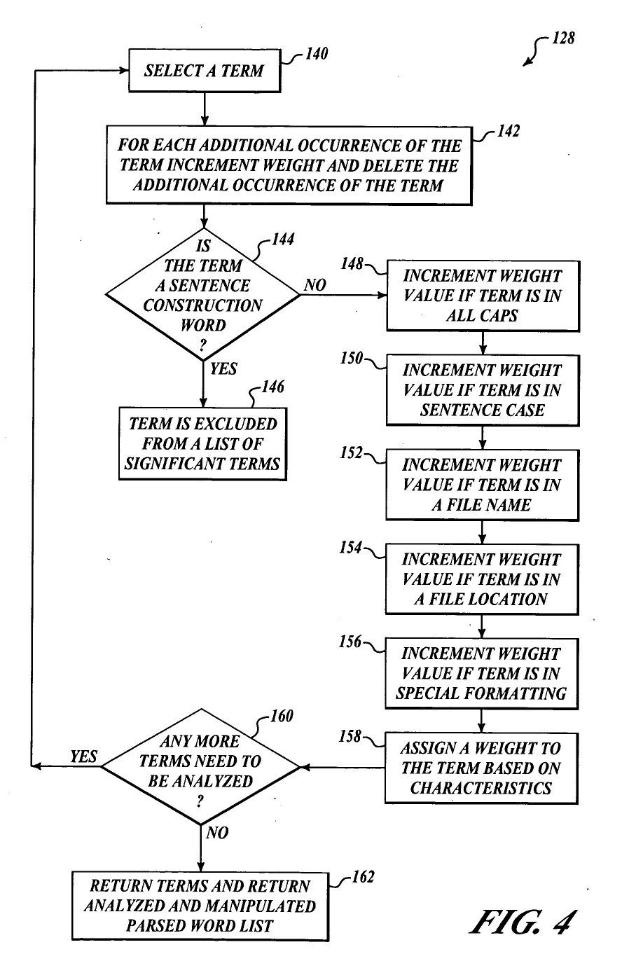

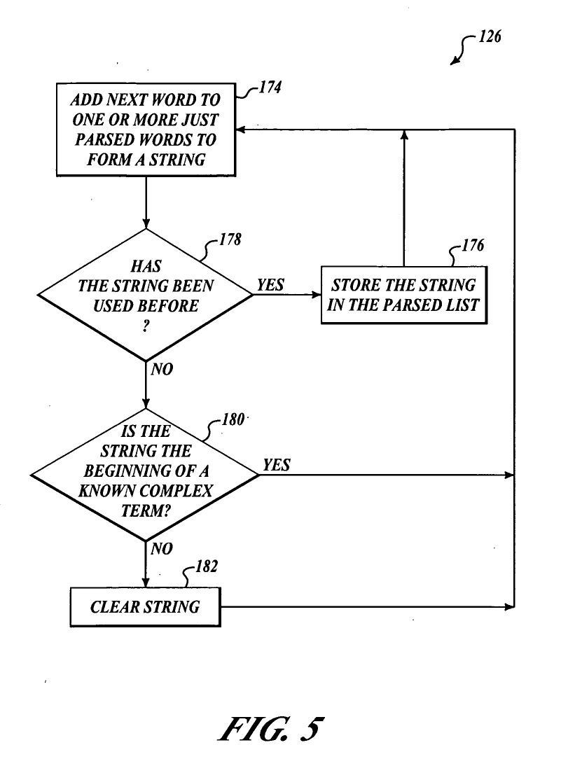

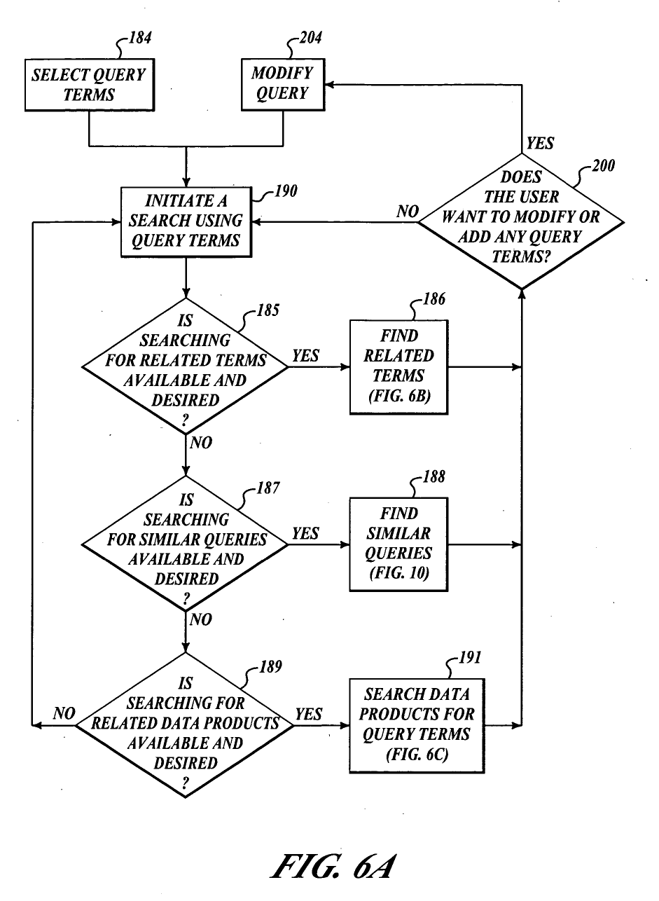

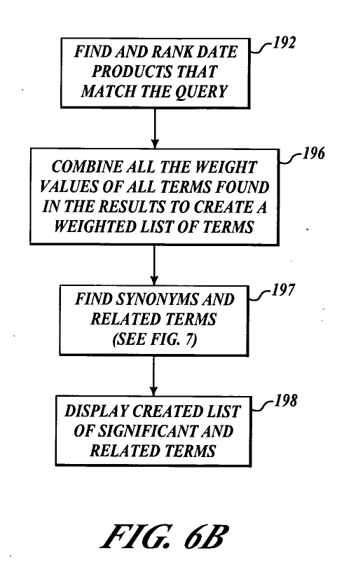

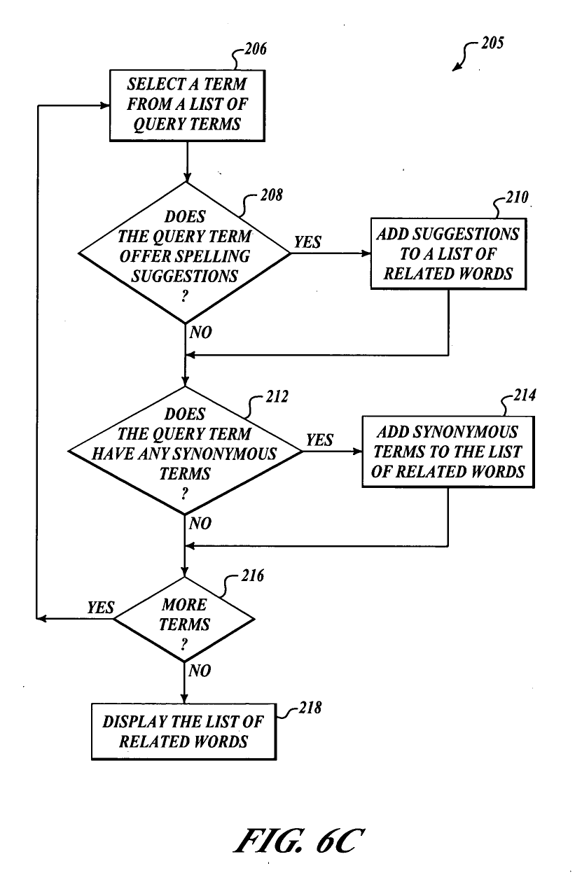

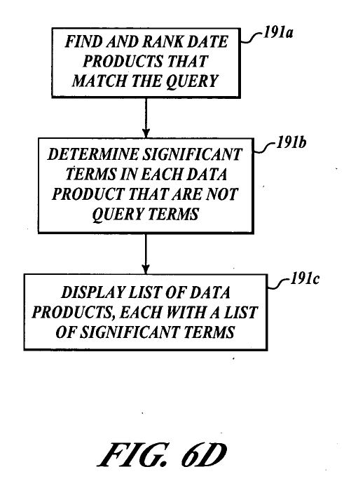

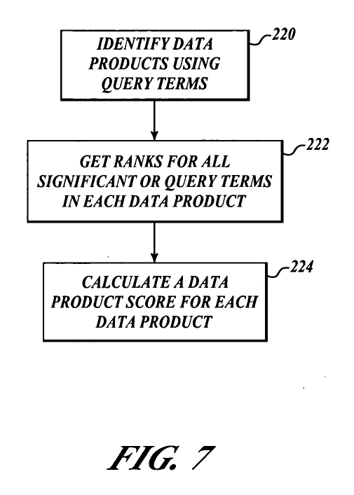

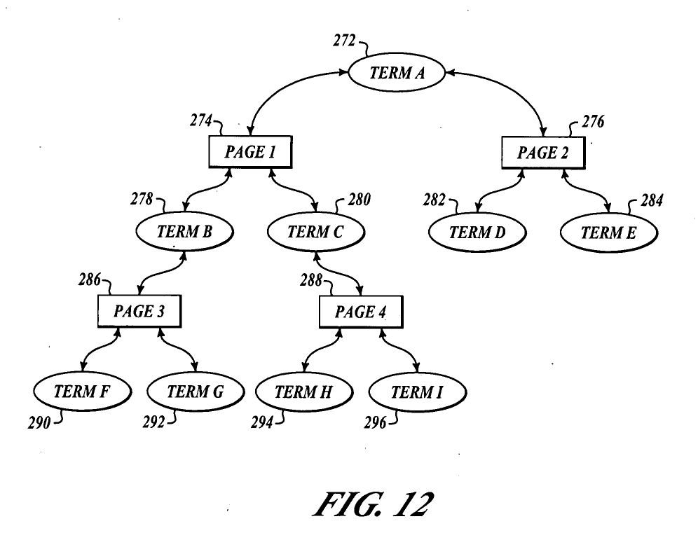

In one embodiment, an application program run by the server 104 or computer 101 creates initial database tables. The tables store significant terms found in each of a plurality of the data products, as well as the relationships between each table, and data product locations. Example database tables are described in FIG. 11. The computer 101 or server 104 includes an application program that parses and ranks terms in each of the plurality of data products. This is described in more detail in FIG. 3. The computer 101 or server 104 includes an application program that displays results of a search. This process is described in more detail in FIG. 6. The application program monitors the data products for changes and updates the database tables when a change has occurred or a new data product has been made available.

In one embodiment a data product search using related concepts is executed on a stand alone computer 101. In one embodiment a data product search using related concepts is executed on a computer 101 connected to a plurality of computers 103, a server 104, a data storage center 106, and/or a network 108, such as an intranet or the Internet. In one embodiment a data product search using related concepts is executed on the Internet allowing a user to search a plurality of internet pages.

In one embodiment, the data products could be of any format containing text, including but not limited to a word processing document, a spreadsheet, a database, a web page, and/or a text file.

FIG. 2 shows a method formed in accordance with an embodiment of the present invention. At block 105 a database is setup through a data product parsing function, which will be described in more detail below in FIGS. 3-5. At block 110 a search of the database is performed by searching the results of the data product parsing function stored in the database. The search is described in more detail below with respect to FIGS. 6-10.

FIG. 3 shows an example method (block 105) for parsing data products and retrieving significant terms from each data product in accordance with a first embodiment. The method (block 105) begins at a block 124 by determining the type of a data product to be parsed.

After a data product type has been identified, at block 126, a parsing routine, which is based on the identified data product type, parses each word and the parsed words are entered into a parsed list of terms for each data product. For future reference, a term includes one or more words. At block 128, the terms are analyzed and weighted. This step is described in FIG. 4. At block 130, the remaining terms, after each term has been analyzed and manipulated, are stored in a list of significant terms in the database. The list of terms is stored in the database with each term being linked to its corresponding data product.

FIG. 4 further describes the method described at block 128 of FIG. 3. At block 140, a term is selected from the generated parsed list of terms. At block 142, for each occurrence of the term, a weight value is incremented and the additional occurrence of the term is deleted from the list. A term's weight value is defined as a number assigned to a word, such that in a computation the word's effect on the computation reflects its importance. At decision block 144, the term is tested to determine whether the word is a sentence construction word. If the term is a sentence construction word then the term is removed and excluded from the parsed list see block 146.

Sentence construction words are those used commonly in written text to build sentences, but have very little content information. They include words such as “and”, “the”, “this”, “of”. Because they are common, the algorithm for determining significance of a term might incorrectly assign a high significance to these words that carry very little meaning. A configurable list of sentence construction words is maintained and no term is added to the term storage or weighted for a data product that is found in this list. Any query terms which match a sentence construction word are ignored, and if all the terms in a query are sentence construction words, the query is rejected.

In one embodiment a term's weight value is incremented if the term is in all caps see block 148. A term's weight value is incremented if the term is in sentence case see block 150. Sentence case is defined as a term that is all lower case, or is just capitalized because it follows a period, i.e. is the start of a new sentence. A term's weight value is incremented if the term is in the name of the data product containing the term see block 152. A term's weight value is incremented if the term is in the file location of the data product see block 154. A term's weight value is incremented if the term has any special formatting see block 156. For example, special formatting includes italics, underline, larger font than most of the other text in the data product, quotations marks and/or strikethrough. Additional factors can be used to generate or adjust weights of terms, depending upon the data product format and application needs. In one embodiment, a term's weight value is incremented based on a terms proximity to a query term found in the data product (See FIG. 6). In another embodiment, a term's weight value is increased or decreased if the term is found within specified sections of the data product. One embodiment would adjust the term's weight based on a dictionary of terms suitable to the data product and application system. After a term has been analyzed the final weight is then assigned to the term 158. At decision block 160 the parsed list is checked to determine if there are any additional terms to be analyzed. If so, the method returns to block 140 to enable the next term to be analyzed. If there are not any additional terms to be analyzed, then the weighted parsed list is returned to block 130 in FIG. 3.

Terms are determined to be insignificant by ranking all of the terms in a data product and then finding the value where terms begin a sequence (of configurable length) with the same value. It can be assumed that a sequence of terms with the same value reflects terms that are not particularly descriptive of the contents of the data product. All terms with weight values above the weight value of the terms with the first repeated value will be flagged as significant terms, so long as they are not sentence construction words.

FIG. 5 further shows a method described at block 126 of FIG. 3 for parsing a word and entering that word into a list based upon multiple words or terms in accordance with an embodiment of the present invention. The primary function of the method described in FIG. 5 is to allow the database to learn and assign a weight value to phrases or combinations of terms. In one embodiment, a complex term is defined as a term containing phrases or combinations of terms. When building a list of complex terms, the method will add the next term to one or more just parsed words to form a string, see block 174. The method will then search the database to determine whether the string has been used before. If the string is a complex term that has been used before, at block 176, the string is stored in the parsed list, then the method returns to block 174. If it is not a known complex term, then the string is checked to see if it is the beginning of a known complex term see block 180. If the string is the beginning of a complex term, the method returns to block 174. If the string is not the beginning of a known complex term, then the string is cleared at block 182 and the method returns to block 174.

FIG. 6A shows an example method from the block 110 of FIG. 2 for initiating a search using one or more query terms. A search is initiated when a user selects a query term or string of query terms (block 184). In one embodiment, when a user begins a search, the query terms are formatted into a proper syntax to conduct a search. A query term is defined as a term or set of terms (search string) used in a search. Each term will be appended to a search string with an appropriate modifier. A term is entered through a user interface as shown in FIGS. 16-22. Once a query has been started by the user (block 190), then the desired type of query is identified. If a Related Term Search is requested at block 185, the query is evaluated and output is produced at block 186. If a Similar Queries search is requested at block 187, the query is evaluated and output is produced at block 188. If a Data Products search is requested at block 189, the query is evaluated and output is produced at block 191. At block 200 after the output of a search is presented, the user has the choice of further refining their query (block 204), executing a different search (block 190) or viewing the Data Product from a Data Product or Similar Query search.

FIG. 6B shows an example method from block 186 of FIG. 6A for executing a related terms search. The query term or string is used to identify at least one data product, and rank all the data products that are found at block 192. If a search is executed and no data products are found, then the user will be given the opportunity to edit the query term(s). At the completion of a search where at least one data product is found that contains the query term(s), at block 196, the weight values of all of the significant terms in each of the found data products are adjusted by the data product's query score and combined to those from the other data products to create a weighted list of significant terms. The list of synonymous terms and potentially corrected spellings are generated in block 197. Finally, at block 198, the created weighted list of related terms is displayed to a user in ranked order on a visual display.

FIG. 6C shows a method 205 for determining possible additional search terms by offering synonyms and spelling suggestions during a search. At block 206, a query term is selected. The selected term is analyzed to determine if the term has any alternate spelling suggestions at block 208. If the term does have an alternate spelling then the alternate spelling is added to a list of related words see block 210. In an alternate embodiment, the user can alter the weight of different spelling suggestions. Next, the term is analyzed to determine if the term has any synonymous terms at block 212. If the term has one or more synonymous terms, then the synonymous term(s) is added to the list of related words at block 214. At block 216, the method 205 returns to block 206 if there are significant query terms in the query string that have not been analyzed. Once all of the search terms in the query string have been analyzed, the list of related words is displayed at block 218. The words in the list of related words can be then selected by the user to alter the original search terms. In an alternate embodiment, the user can alter the significance of different spelling suggestions.

FIG. 6D shows a method of block 191 of FIG. 6A for executing a Data Products Search. The query term or string is used to generate a list of data products and rank them at block 191a. If a search is executed and no data products are found, then the user will be given the opportunity to edit the query term(s). At block 191b, the weight values of the significant terms in the found data products that are not query terms are used to rank the terms within each data product. Finally, at block 191c, the created weighted list of data products and their significant terms is displayed to a user in ranked order on a visual display.

FIG. 7 shows the method of block 192 of FIG. 6B or 191a of FIG. 6D to determine which data products match the query, and rank them by how relevant they are to the query. At block 220 the query terms are used to identify at least one data product that satisfies the query. At block 222 the ranks for all the query terms and data product significant terms are loaded for each data product. At block 224 a score is calculated for each data product from the term rank for each query term that was found in list of terms for the data product. The list of data products, their query score and their significant terms are returned to FIG. 6B or FIG. 6D.

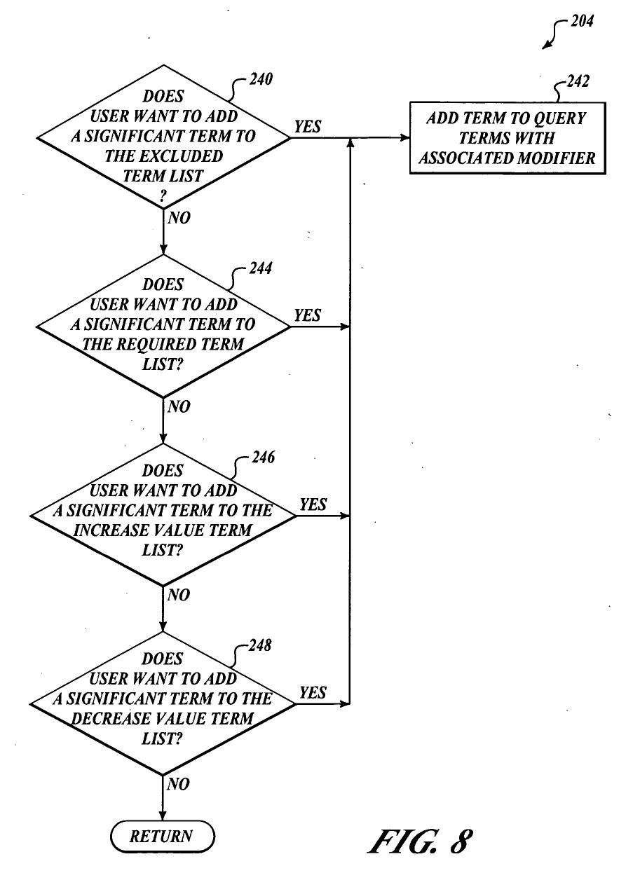

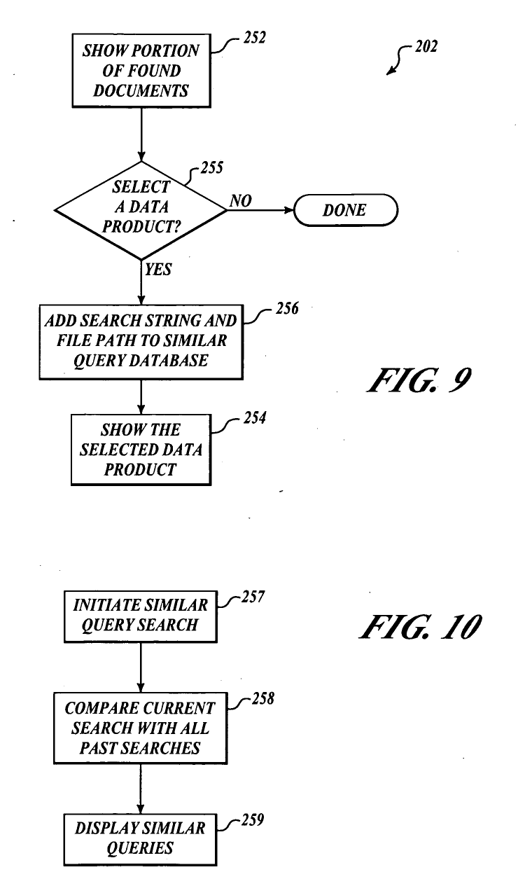

FIG. 8 shows the method of block 204 shown in FIG. 6 for altering the significance of a search term in accordance with an embodiment of the present invention. Once a list of significant terms is displayed to a user, the user can add one of the significant terms to an excluded term list at block 240. If the term is selected as an excluded term, then the term is added to the search query with an excluded modifier 242. The excluded modifier is a symbol that identifies the weight value of the significant term as excluded. If the user does not choose to add the term to the excluded word list, then the user may choose to add the term to the required term list at block 244. If the term is selected as a required term, then the term is added to the search query with a required modifier at block 242. The required modifier is a symbol that identifies the weight value of the term as required. If the user does not choose to add the term to the required word list, then the user may choose to add the term to an increase value term list at block 246. If the term is selected as an increase value term, then the term is added to the search query with an increase modifier at block 242. The increase modifier is a symbol that identifies the weight value of the term as increase. If the user does not choose to add the term to the increase value word list, then the user may choose to add the term to the decrease value term list at block 248. If the term is selected as a decrease value term, then the term is added to the search query with a decrease modifier at block 242. The decrease modifier is a symbol that identifies the weight value of the term as decrease. The user may choose not to add or modify a query term at all.

In one embodiment, the definition of the weight value term “required” is any data product included in the results must include this term. Additionally, the term's rank in the data product is added to the data product rank when calculating the data product's query rank.

In one embodiment, the definition of the weight value term “increase” is any data products containing this term will have the term's rank in the data product added to the data product rank when calculating the data product's query rank. An “increase” term is a term that is desirable to the user.

In one embodiment, the definition of the weight value term “decrease” is any data products containing this term will have the term's rank subtracted from the data product rank when calculating the data product's query rank. A “decrease” term is a term that is undesirable to the user.

In one embodiment, the definition of the weight value term “exclude” is any data product included in the results must not include this term. Accordingly, no change to the query rank is made for these terms.

In one embodiment, in order to increase a term, an algorithm is used to manipulate the assigned weights of the found terms. Once a search is started, each of the query terms is assigned to a variable name. Each of the data products that contain the term is found, and all the terms in the data products are identified.

For example, there are three query terms. Each one of these terms is assigned the value of Qt1=Query Term 1; Qt2=Query Term 2, and Qt3=Query Term 3. In this example there is also three data products found A, B, and C. Data product A, contains significant terms 1, 2, 3, and 4. Data product B, contains significant terms 2, 4, and 6. Data product C, contains significant terms 1, 3, and 5. A data product's ranking is based on the following formula. The total rank of a data product is determined by the weight of the query terms found in the data product. In one embodiment, the data product's total ranking is further adjusted by an analysis of all of the data products, such as references from one data product to another, or the location of the data products in the system. In one embodiment, to reflect the user's recent interest in a set of related topics, the data product's ranking is increased when it includes any terms that have been used recently in other queries, by the weight of those terms in the data product. For example the weight of Data product A equals the weight of Term 1 plus the weight of Term 2 plus the weight of Term 3. The total value of each data product is stored temporarily in memory and the data products are ranked from highest score to lowest score.

Simultaneously, the significant terms in the data product are ranked and set up on a graphical user interface. The terms that do not match the query terms are ranked. For example the Rank of Term 4 in Data product A is equal to the Rank of Data product A multiplied by the weight of Term 4 in Data product A. Then to find the final rank of Term 4 all instances of the Term 4 are added up across all data products. For example, in this example Term 4 is found in Data products A and B; therefore the rank of Term 4 in A is added to the rank of Term 4 in B, to determine the final rank of Term 4.

All terms in the query are preset as “increase” terms. This shows that the user has selected to increase the weight value of the term in any data product found in any search performed. Other options of manipulating a term are require, exclude and decrease. When a term is required, it must be found in the data product. If a term is excluded, it cannot be found in the data product; finally if a term is decreased the weight of that term is subtracted from the total rank of a data product. For example, if in the above example Qt4 is added as a “decrease,” The rank of Data product A equals the weight of Term 1 plus the weight of Term 2 plus the weight of Term 3 minus the weight of Term 4; thus giving Data product A a lower weight then in the previous search.

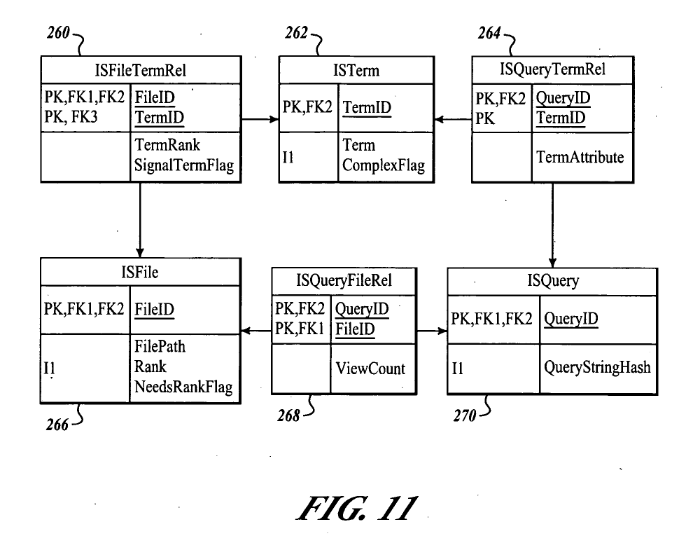

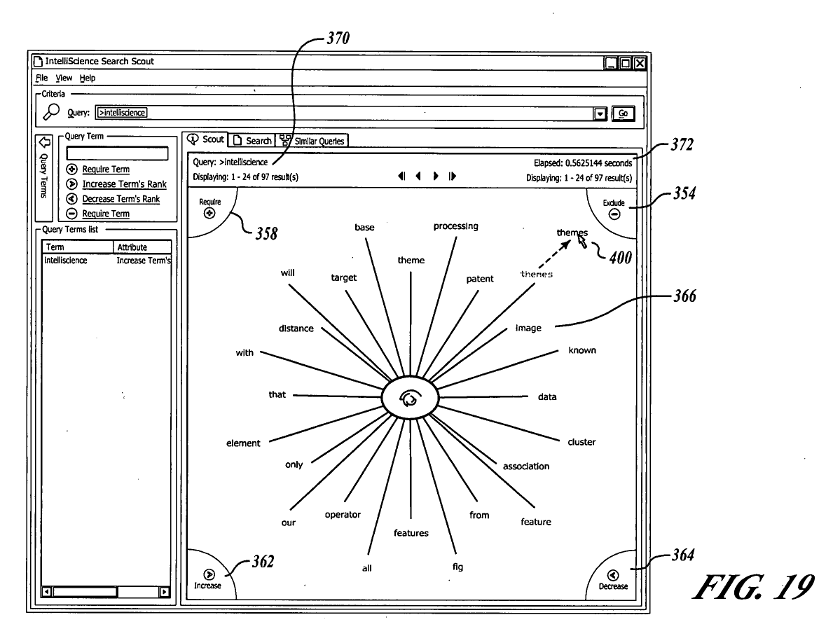

FIG. 9 shows a method 202 for selecting data products in accordance with an embodiment of the present invention. Once a data product is displayed to a user see block 252 and FIG. 18, the user can select the displayed data product see block 255. If the user selects the data product, then the query search string and the data product path are added to a similar queries database see block 256 and the data product is shown see block 254. The similar queries database stores a query sting every time a user selects a data product resulting from a search. This allows for the automatic comparison of a search to searches that others have done. If the user does not select a data product, the method is complete, see block 253.

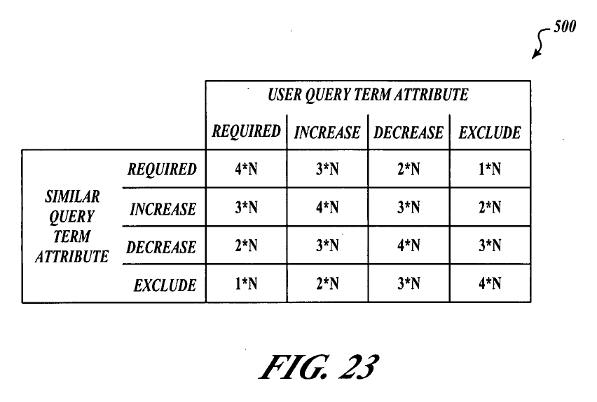

In one embodiment there is a similar queries option. The similar queries option allows the user to review queries that have been executed in the past that have some relation to their current query. When the similar queries tab is selected, a set of results that past users found helpful is displayed see FIG. 22.

In one embodiment the similar queries tab is implemented by loading a set of queries that contain any terms that match any of the terms used by the user. Similarity between a past query and the user's current query is calculated by selecting each term in a past query that matches the current query, and then adding the value from a similarity matrix (see FIG. 23) to determine a similarity score. Finally the similar queries list is sorted form highest score to lowest score. Typically for queries with the same similarity score, the query with the fewest additional terms will be higher than one with more additional terms.

FIG. 10 shows a method of displaying a list of similar queries in an embodiment of the present invention. At block 257, a similar queries search is initiated by the user selecting a similar queries tab (see FIG. 22). At block 258, the current query is compared with all past queries. In order to make the comparison a similarity matrix is used (see FIG. 23). If similar queries are found, the data products that were selected during the past similar queries are displayed to the user at block 259. The similar queries option allows a user to see results that past users have found, the amount of times that a particular result has been selected, and/or the similarity between the current query and the past query.

FIG. 11 shows major database relationship tables 260-270. There are several primary tables that include a unique key. The tables include a table 262 that defines a term to the system. The entries in the table 262 can be created from words found in the data products on the system and from terms used in queries by a user. The tables ISFile 266, ISTerm 262 and ISQuery 270 are the primary elements. The tables ISFileTermRel 260 records relations between ISFile 266 and ISTerm 262 (where terms exist in data products). The table ISQueryFileRel 268 records relations between ISQuery 270 and ISFile 266 (which files were access from search queries). ISQueryTermRel 264 records relations between ISQuery 270 and ISTerm 262 (which terms are present in each query).

A ISFile 266 that defines a data product to the system and a ISQuery 270 that defines a query when a user has viewed a data product are defined. In one embodiment, the ISQuery 270 provides the basis for a similar queries search. ISFileTermRel 260 defines the relationship between data products (266) and terms (262). ISQueryTermRel 264 defines relationships between queries (270) and terms (262). ISQueryFileRel 268 defines relationships between queries (270) and data products (266)

The foregoing tables may also include various variables in order to ensure correct operation. ISFile 266 may also include the following: a unique data product identifier that is assigned by a database; a stored location or path of the data product; a Boolean rank flag to determine whether the data product has been ranked. Typically priority is given to data products that have not been ranked.

ISFileTermRel 260 includes a key for a term, a key for a data product, and a calculated value for the term in the data product, and/or a Boolean flag which indicates that this term is a signal term in this data product.

ISTerm 262 includes a unique identifier for the term assigned by a database, the text of the term, and/or a Boolean flag indicating whether the term has embedded spaces, and needs special processing when looking for the term in a data product.

ISQueryTermRel 264 includes a key for a term, key for a query, and/or a string indicating how the term is used in the query, such as is the term required, increased in value, decreased in value, or excluded.

ISQueryFileRel 268 includes a key for the query table, a key for the data product table, and how many times a data product has been viewed form results of a query.

ISQuery 270 which defines a query when a user has viewed a data product, and includes a unique identifier for a term assigned by a database and/or a numeric value of a query terms and attributes used to quickly identify potential equal queries for lookup.

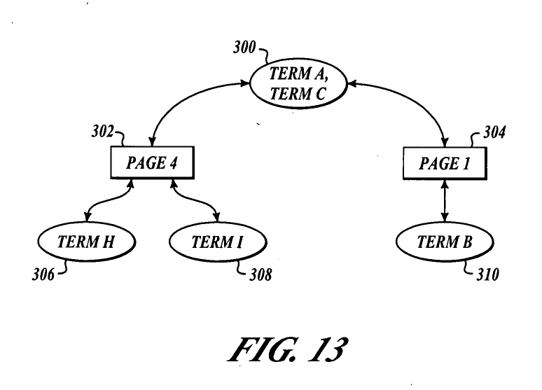

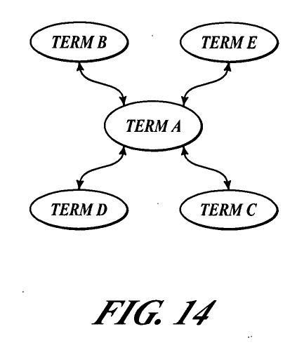

FIG. 12 shows an example relationship network of search terms and data products when the query search term is Term A 272. In FIG. 12 each oval represents a query search term and each rectangle represents a data product. This relationship network is based on each data products relationship to Term A 272. Term A 272 can be found on Page 1 274 and Page 2 276. In one embodiment the Terms unique to Page 1 274 signify one theme of data product's and the Terms unique to Page 2 276 signify a different theme of data products. Page 1 274 also includes Terms B 278 and C 280. Page 2 276 also includes Terms D 282 and E 284. From the significant terms on Page 1 274, there are two additional pages found. Page 3 286 contains both Term A 272 and Term B 278. Page 3 286, also includes Term F 290 and Term G 292. Page 4 288 includes Term A 272 and Term C 280 (see FIG. 13). Page 4 288 further includes Term H 294 and Term 1296. A results set can be more clearly defined by selecting an additional term from Page 1 or Page 2. Pages 1-4 refer to distinct data products.

FIG. 13 shows a relationship network when the search terms are Terms A and C 300. Term A represents Term A 272 found in FIG. 12 and Term C represents Term A 280 found in FIG. 12. The combination of Terms A and C 300 reduces the total number of pages shown by the relationship network in FIG. 12. The combination of Term A and Term C result in only two pages, Page 4 302 and Page 1 304. The remaining significant terms are Term H 306, Term 1308, and Term B 310.

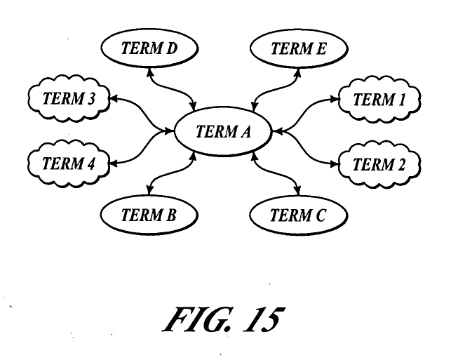

FIG. 14 demonstrates the relationship between terms in a chosen subject from a query. The most significant terms from the useful pages are displayed. This allows the users to select appropriate terms that can narrow a search. The relationship is shown by showing a term as an oval and linking the terms using arrows. A search for Term A would likely find data products containing at least one of Terms B-E. Therefore by using significant terms a user is more likely to find the result they are looking for.

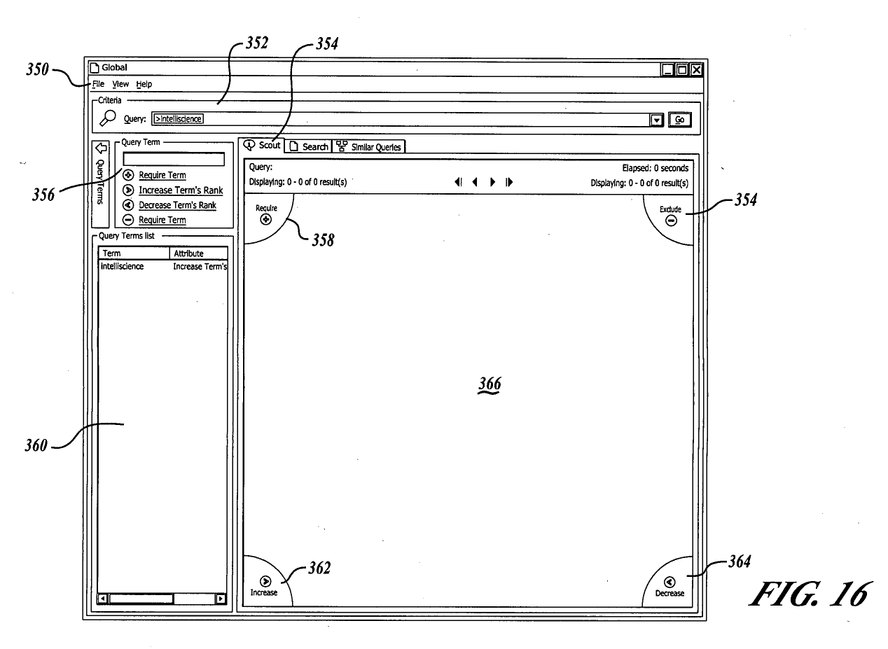

FIG. 15 demonstrates the relationship shown in FIG. 14 and also the relationship between terms in a chosen subject and further suggests related terms. In one embodiment there are not only terms that are related, but there are additional terms that the user did not think of such as synonyms and different spellings. These additional terms are shown as Terms 1-4.

FIG. 16 shows a screen shot of a graphical user interface (GUI). The GUI includes a menu bar 350. This menu bar includes drop down menu's that are generally known in the art. Below the menu bar is a query text box 352. The query text box 352 includes a field where a user enters terms for a query. Text can also be added to this block using other means included in the GUI. In one embodiment, the GUI includes a text box 356 that allows a user to enter additional query terms. The entered terms will be appended to the end of a string in the query text box 352. A user can choose to a scout tab 354 to show a listing of terms in data products that were found using the terms in the query text box 352. The listing of terms is ranked by the weight values of the terms that appear in the found data products.

The text box 356 allows a user to enter a term and then further select, as an example, “require term.” The term shown in box 356 will then be appended to the string in the text box 352 with the character “+” preceding the entered term. This signifies to the system that the term directly following the “+” is a required term.

Directly below the text box 356 is a list box 360. The list box 360 includes a list of terms currently used in the query. The list box 360 includes the attribute of the searched term. In one embodiment an attribute is the designation given to the term by a user, such as require, exclude, increase value, or decrease value. When a term in the list box 360 is shown and selected by a user, the selected term is sent to the text box 356 in order to allow a user to further modify the term. A results display area 366 includes a require section 358, an exclude section 354, an increase section 362 and/or a decrease section 364. In an alternate embodiment a data product search using related concepts is implemented on or in conjunction with a preexisting search application.

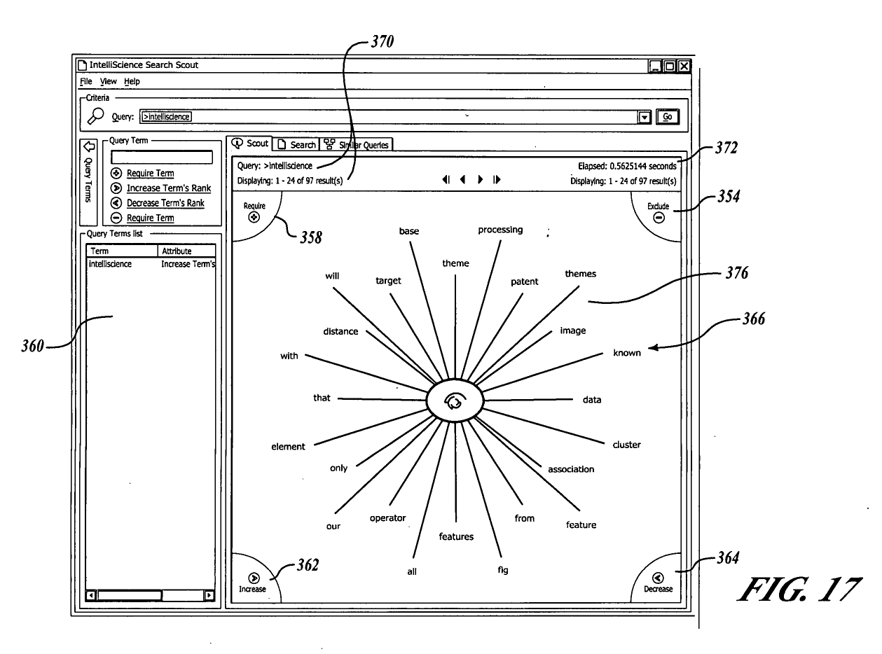

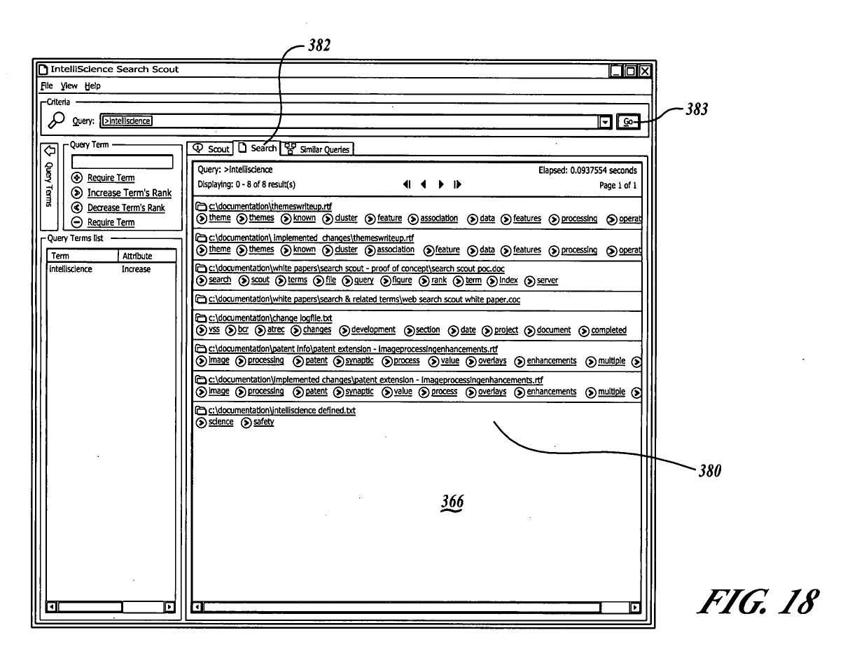

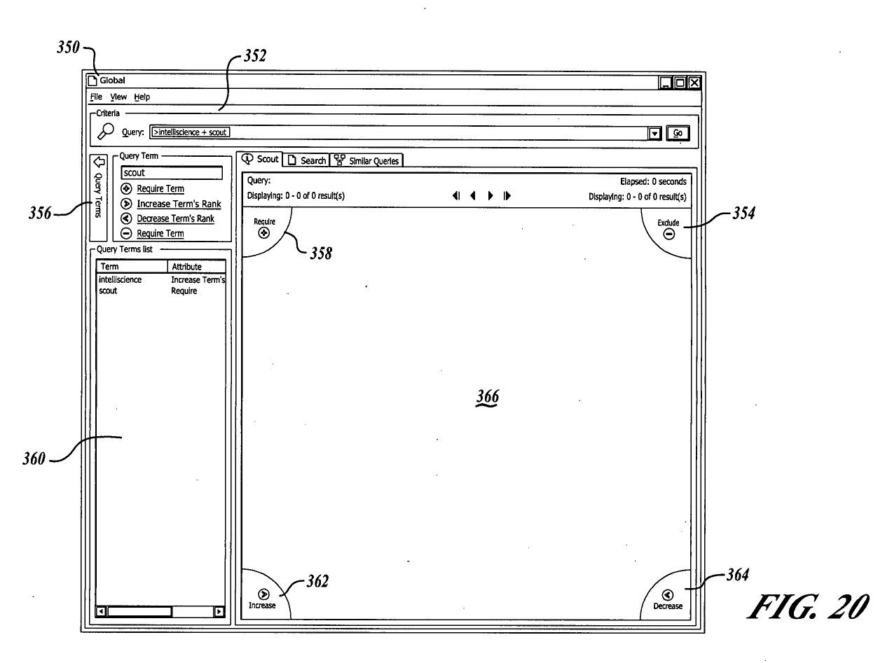

FIG. 17 shows a screen shot of a set of results from a Related Terms or Scout query in one embodiment. After an initial search, the results display area 366 is populated with a result statistics field 370, a search statistics field 372, and/or a graphical display 376 of significant terms found in the search. The result statistics field 370 shows the number of significant terms found, and the search string used. The search statistics field 372 displays the amount of time it took to conduct the search. In the display 376 the terms found in the search are displayed. In one embodiment, the terms are shown in a circular and/or clockwise manner. The most heavily weighted term is displayed at 12 o'clock and the weights of the terms decrease with a progression of displayed terms in the clockwise direction. Each term in the display 376 is highlighted when a cursor control device, such as a mouse, places a cursor over or near a term. The cursor can be activated by a user using the cursor control device to select a term and to drag it to any of the sections 354, 358, 362, 364. When a significant term is dragged onto one of the sections 354, 358, 362, 364 and dropped, the term with its corresponding modifying characteristic is added to the text block 352 and to the list box 360, see also FIG. 19.

FIG. 18 is a screen shot of one embodiment showing a list of data products found after a Data Products query. In the display area 366, a list of data products 380 are shown after a user chooses to have their results displayed by selection of a search tab 382 and pressing the “GO” button 383. The list 380 shows title, the data product file path, and/or an abstract (not shown). Further under each term is a list of the most heavily weighted significant terms found in that data product. The terms shown under a data product in the list 380 can be selected by the user to refine the present search, adding them to the query either as Required, Increase Decrease or Excluded. When the user selects a data product from the list 380, the data product is presented to the user.

FIG. 19 is a screen shot of one embodiment showing a significant term being moved from the display area 366 to the section 354. The term “themes” 400 is selected using the cursor control device and moved to the “exclude” section 354. Once the term is dropped in the section 354, the search query is appended with the term “themes” with the “−” modifier appearing next to the displayed term.

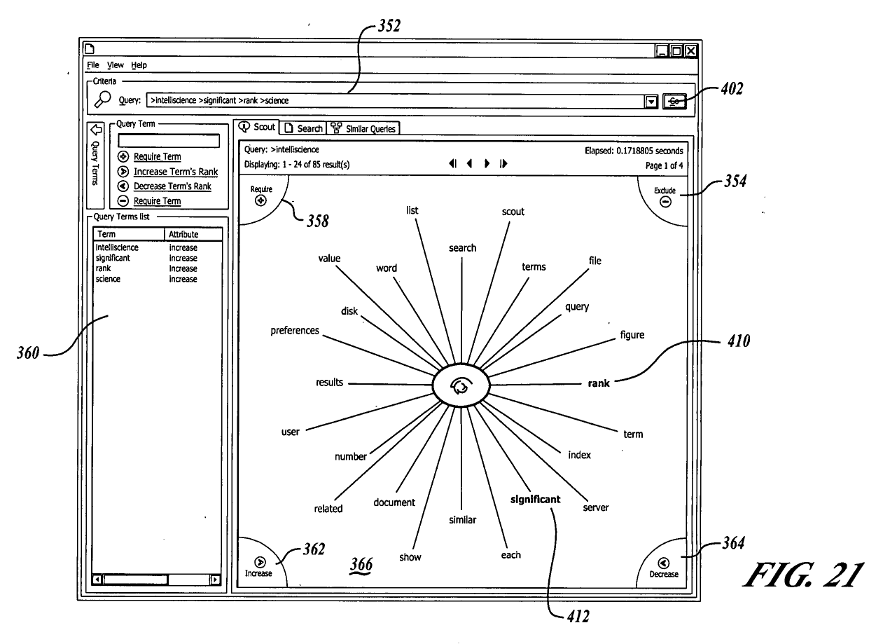

FIG. 20 is a screen shot of one embodiment showing the term “scout” being added to the search query. The term “scout” is added to text box 356. Then the user selects the require term function by activating the cursor over the “+,” “Require Term,” or by a selection from a pull-down menu. The term is appended to text box 352 and added to the list box 360.

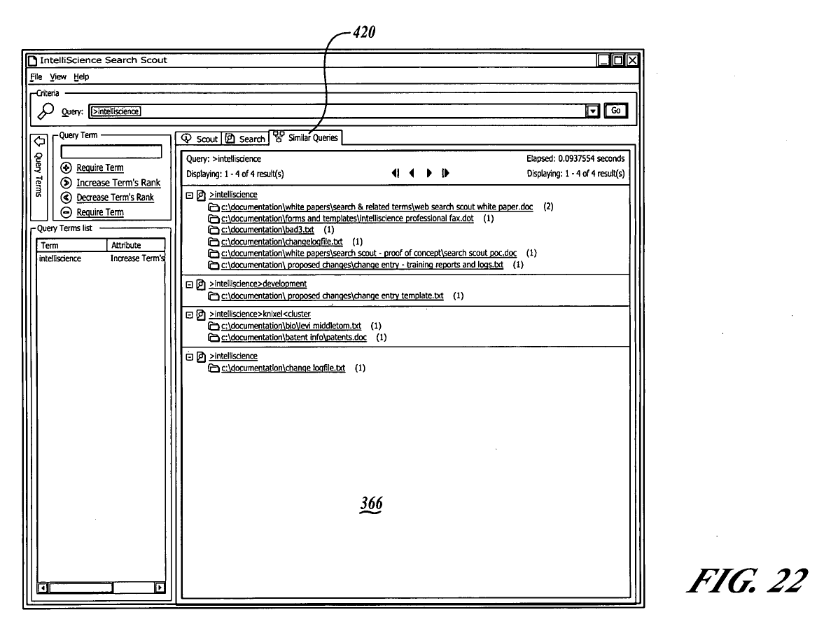

FIG. 21 is a screen shot showing terms after they have been added to the query. The terms 410 and 412 have already been added to the text box 352 and the list box 360. In this screen shot a new search is ready to be run with the additional query terms. When the user activates a Go button 402, a new search is performed and a new graphical display of significant terms is presented.

FIG. 22 is a screen shot showing a similar queries screen. In order to get to the similar queries screen, a user selects a similar queries tab 420. Shown in the display area 366 are the terms of similar queries and the paths of data products that were selected by previous user. Also shown is an access count that identifies the number of times that data product was selected when that particular query was performed. The query 422 is a hyperlink allowing the user to re-run the similar search. The data product paths 424 are also hyperlinked allowing a user to go directly to the data product. In one embodiment, when the user accesses a data product, an access count for that data product is incremented in the database. In one embodiment, the similar queries used to access each data product are reported to the application handling each data product. For example, if data products are web pages, the similar queries used to access each web page can be used to notify the organization hosting the pages. The hosting organization is then able to target their pages to the largest set of users looking for them.

To determine a ranking of which saved queries are most similar to the user's query, the terms of the user's query are compared to the terms used in the similar queries.

In one embodiment, given a query with N attributes, multiply each entry in the matrix shown in FIG. 23 by N. The values in the figure are preferably positive, and not negative, because the system is considering queries with some element of similarity to the user's query, thus the most similar query has all the same terms with all the same attributes, and the most dissimilar queries have no terms in common with the user's query. In an alternate embodiment other means for determining a query's similarity to a given query include: modifying the values in the table in FIG. 23 to provide different weighting to attribute similarity and dissimilarity. One embodiment expands the term comparison to allow for similar terms (not exact matches) such as synonyms, alternate spellings, root words and plurals. For example, if the query from the user had 4 terms, the matrix could be:

| | | User Query Term Attribute | | | |
|---|---|---|---|---|---|
| | | Require | Increase | Decrease | Exclude |
| Similar | Require | 16 | 12 | 8 | 4 |
| Query | Increase | 12 | 16 | 12 | 8 |
| Term | Decrease | 8 | 12 | 16 | 12 |
| Attribute | Exclude | 4 | 8 | 12 | 16 |

A term similarity score is calculated for each term in the user's query whose literal value matches one of the terms used in a similar query. Those term similarity scores are summed up and become the query similarity score. The number of terms in the potentially similar query that are not found in the user's query are stored temporarily.

When comparing the ranks of two queries with the same query similarity score to present a sorted list, the query with the most additional terms not found in the user's query is determined to be the most dissimilar.

### EXAMPLE

If a similar query A had one term that matched and was required by both the user and the similar query, the query's similarity score would be 16.

If a similar query B had two matching terms, one that matched the user's Increase, and one that was required while the user's term was decrease, the query's similarity score would be 16+8=24. Assume that this query has two terms not in the user's query.

If a similar query C has three matching terms, but the user required them and the similar query excluded them, the similar query's similarity score would be 3*4, or 12.

Given these three examples, the queries would be sorted in descending score order as B, A, C.

If a fourth query D also had two matching terms, but one matched the user's decrease, and the other was exclude, then the score would be 16+8=24. Assume that this query has one additional term not in the user's query.

When sorting these by score, the order would be D, B, A, C.

In one embodiment, the server 104 or similar device includes a watch service. When a new data product is made available for searching, an entry is created in a data product table containing the path for the new data product, an initial rank value of 0, and/or a ranking Boolean variable is set to true.

When a data product has been updated as determined by the watch service, the entry in the table for the data product is found and the Boolean variable is set to true. The Boolean value is set to true, because a new ranking needs to be done based on the updated content of the data product. Finally if a data product is deleted then the corresponding entry in the data product table is deleted as well as any relationships with other system tables. In an alternate embodiment a watch service includes a general document repository or an indexing system.

While the preferred embodiment of the invention has been illustrated and described, as noted above, many changes can be made without departing from the spirit and scope of the invention. For example, a data product could be a text file, a webpage or any form of searchable medium. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of searching a plurality of data products stored at one or more locations over a computer-based network, the method comprising:
searching the plurality of data products based on a search string comprising at least one term;
if at least one data product was found from the search, ranking a list of significant terms in the found data products based on a weight value for each of the significant terms in all the found data products; and
displaying the ranked list of significant terms.

2. The method of claim 1, further comprising:
allowing a user to modify the search string by adding at least one search term.

3. The method of claim 2, wherein the at least one search term added to the search string is a significant term included in the ranked list.

4. The method of claim 3, wherein modify includes changing the weight value for the at least one search term added to the search string.

5. The method of claim 4, wherein changing the weight value includes at least one of increasing or decreasing the weight value.

6. The method of claim 2, wherein adding at least one search term includes requiring that the added at least one search term be included in to-be-searched data products.

7. The method of claim 1, further comprising:
allowing a user to modify the search string by changing the weight of at least one of the terms in the search string.

8. The method of claim 7, wherein changing the weight value includes at least one of increasing or decreasing the weight value.

9. The method of claim 1, further comprising:
allowing a user to identify a term in at least one of the search string or the ranked list as an excluded term.

10. The method of claim 2, further comprising:
generating a list of terms synonymous to one or more of the terms in the search string and terms in the ranked list.

11. The method of claim 10, further comprising:
allowing a user to modify the search string by adding one or more of the synonymous terms.

12. The method of claim 2, further comprising:
generating a list of alternate spelling suggestions to one or more of the terms in the search string or terms in the ranked list.

13. The method of claim 12, further comprising:
allowing a user to modify the search string by adding one or more of the alternate spelling suggestions.

14. The method of claim 2, further comprising:
searching the plurality of data products based on the modified search string;
if at least one data product was found from the search based on the modified search string, ranking a new list of significant terms in the found data products based on a weight value for each of the significant terms in all the found data products; and
displaying the new ranked list of significant terms.

15. The method of claim 14, wherein displaying the new ranked list comprises displaying only terms not included in the modified search string.

16. The method of claim 1, further comprising:
presenting at least one data product found by the search;
allowing a user to select one of the presented at least one data product; and
storing the search string used for the search and a location of the selected data product once the data product has been selected by the user.

17. The method of claim 1, further comprising:
comparing the search string with a plurality of search strings stored in a memory; and
displaying a ranked list of closely related search strings that resulted with a selection of a data product.

18. A system for searching a plurality of data products, the system comprising:
a database configured to stored significant term information for the plurality of data products;
a display; and
a processor in data communication with the display and with the database, the processor comprising:
a first component configured to search the plurality of data products using the stored significant term information based on a search string comprising at least one term;
a second component configured to rank a list of significant terms found in a plurality of data products based on a weight value of each significant term in all the found data products, if at least one data product was found from the search; and
a third component configured to display the ranked list of terms
wherein the components are located on at least one of a stand alone computer or a plurality of computers coupled to a network.

19. The system of claim 18, wherein the processor comprises:
a graphical user interface configured to allow a user to modify the search string by adding at least one search term.

20. The system of claim 19, wherein the at least one search term added to the search string is a significant term included in the ranked list.

21. The system of claim 20, wherein the graphical user interface is configured to allow a user to change the weight value for the at least one search term added to the search string.

22. The system of claim 21, wherein the weight value is changed to at least one of a higher or lower weight value.

23. The system of claim 19, wherein the graphical user interface is configured to allow a user to require that the added at least one search term be included in to-be-searched data products.

24. The system of claim 18, wherein the graphical user interface is configured to allow a user to change the weight of at least one of the terms in the search string.

25. The system of claim 24, wherein the weight value is changed to at least one of a higher or lower weight value.

26. The system of claim 18, wherein the graphical user interface is configured to allow a user to identify a term in at least one of the search string or the ranked list as an excluded term.

27. The system of claim 19, wherein the processor comprises:
a fourth component configured to generate a list of terms synonymous to one or more of the terms in the search string and terms in the ranked list, and display the generated list on the display.

28. The system of claim 27, wherein the graphical user interface is configured to allow a user to modify the search string by adding one or more of the synonymous terms.

29. The system of claim 19, further comprising:
a fourth component configured to generate a list of alternate spelling suggestions to one or more of the terms in the search string and terms in the ranked list, and display the generated list on the display.

30. The system of claim 29, wherein the graphical user interface is configured to allow a user to modify the search string by adding one or more of the alternate spelling suggestions.

31. The system of claim 19, wherein the processor comprises:
a fourth component configured to search the plurality of data products based on the modified search string;
a fifth component configured to rank a new list of significant terms in the found data products based on a weight value for each of the significant terms in all the found data products, if at least one data product was found from the search based on the modified search string, and
a sixth component configured to display the new ranked list of significant terms.

32. The system of claim 31, wherein the sixth component displays the new ranked list with only the terms not included in the modified search string.

33. The system of claim 18, wherein the processor comprises:
a fourth component configured to present at least one data product found by the search;
a fifth component configured to allow a user to select one of the presented at least one data product; and
a sixth component configured to store the search string used for the search and a location of the selected data product in the database once the data product has been selected by the user.

34. The system of claim 18, wherein the processor comprises:
a fourth component configured to compare the search string with a plurality of search strings stored in the database; and
a fifth component configured to display a ranked list of closely related search strings that resulted with a selection of a data product.
